(19) United States
(12) Patent Application Publication
(10) Pub. No.: US 2003/0046332 A1
(43) Pub. Date: Mar. 6, 2003

(54) Method and communication system for providing geographic data during the retrieval of information from the www/wap

(76) Inventor: Maximilian Riegel, Nurnberg (DE)

Correspondence Address: MORRISON & FOERSTER LLP, 1650 TYSONS BOULEVARD, SUITE 300, MCLEAN, VA, 22102, US

(21) Appl. No.: 10/239,299

(22) PCT Filed: Mar. 8, 2001
(86) PCT No.: PCT/DE01/00896

(51) Int. Cl. G06F 15/16; H04Q 7/20

(52) U.S. Cl. 709/202; 709/246; 455/466

(57) ABSTRACT

The invention relates to a method and a communications system for providing geographic data during the retrieval of information from a packet-oriented communications system. The aim of the invention is to enable information which has a geographic location reference to be requested from a network server by a data terminal (1), e.g. a WAP-enabled mobile station, via a radio communication link (V), using an information request (2). In order to provide geographic data during the retrieval of information in a simple and anonymous manner, the request for information is routed via an interfacing proxy-server (5) which supplements the information request (2) with geographic information (7).

The invention relates to a method and a communications system for making geographical data available when data are called up in a service WWW or WAP capability.

The World Wide Web (WWW) is a communications network that makes it possible to call up information by means of an Internet protocol, particularly the HTTP (Hyper Text Transfer Protocol), by way of the Internet. In this connection, the information desired by the user is identified by an address, a so-called URL (Unified Resource Locator). In this connection, the URL has the form “http://www.servername.domain/pathname/filename.html” and is sent to the relevant HTTP server in a request message when the information is requested at this address.

The URL of a document describes the location and is also a condition of the memory address where the document is stored. This location can have a relationship with the geographical location for which the information made available is intended. For example, on the server “www.muenchen.de” one will primarily obtain information about goods and services offered in the city of Munich. However, this geographical connection between the server name and the location for which the data are intended is not defined in Internet specifications, but is purely a coincidence and is at most a result of conventions within the WWW. In the case of several towns with the same name, only one of these towns will get the URL, particularly the town that asks for it first. For this reason, the geographical reference for information that has been available in the WWW until now is generally arbitrary and random.

A better quality of information with a geographical reference, such as questions as to which restaurants are in the vicinity of the requesting party's present location or of a target location, or where the nearest hotel is located, are only obtained if the information request contains concrete information about the desired geographical location. This information can then be evaluated by the relevant Web server, in order to sort and select the available information in a targeted manner. However, this, too, is only possible within restrictions, since, while it is easily possible to request information concerning a certain municipality, the person seeking the information often does not know the names of adjacent municipalities that might be even more interesting.

Fundamentally, Web contents could be handled in such a way that the subscriber or user enters his/her position into an electronic form before sending a request, and the relevant Web server makes this form available and evaluates it.

An implicit form of transmitting geographical data in special protocol elements in the HTTP protocol would be significantly more user-friendly and efficient, according to current discussions among persons skilled in the art, because a uniform form of location information would be available for all inquiries, because no special inquiry screens that result in protocol overload (protocol overhead) and installation effort would be required, because automatically determined data for the geographical position could be used, and because the amount of additional data to be transmitted would be smaller.

In this connection, different protocol elements are being discussed for the handling of geographically dependent data. One element under discussion is the expansion of HTML documents by a special header or a special META-TAG, with which a geographical reference can be indicated in the network document or Web document. This header can be utilized by corresponding search engines to serve the party seeking the information with the desired, geographically relevant information. Also under discussion is a corresponding expansion of the HTTP header, in which corresponding geographical information could also be passed along with the inquiry.

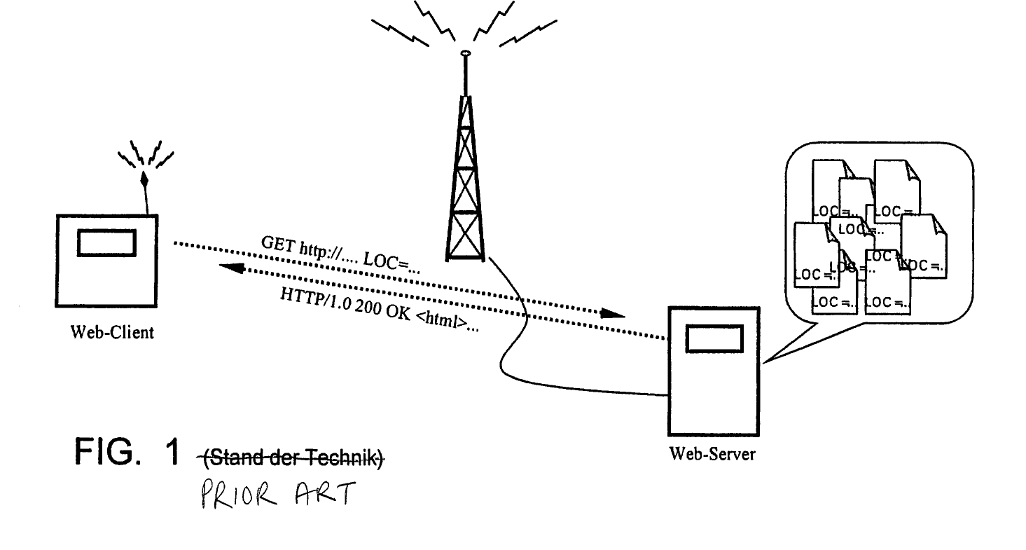

Such a situation is outlined in FIG. 1. A network or Web client requests information with a location reference from a network or Web server, by way of a communications connection, particularly a mobile communications connection, and receives an answer. In this connection, the Web server's reply is location-related.

With these expansions, geographically dependent data can be stored in the server and called up by the client, in the conventional client-server configuration, with communication between the inquiring party (client) and the server.

In this connection, the client transmits the desired geographical position, along with the desired URL, from his/her own Web browser, in the HTTP header, and the Web server uses this information to select from the existing number of available documents or data those that are as geographically close as possible.

However, this solution has several weaknesses when implemented in a practical situation:

The currently available and wide-spread Web browsers do not possess the capacity to transmit the geographical position in the HTTP header, so that special Web browsers first have to be developed and distributed in order to use the method. This is not a simple matter, particularly in a world dominated by two large providers.

Furthermore, the special requirements concerning data privacy protection are not taken into consideration. Using the geographical position of the requesting party as transmitted in the HTTP header, any information provider in the network could draw up detailed movement profiles of individuals.

A geographical position of an inquiring party, possibly determined automatically in the Internet access network, must preferably be transmitted to the inquiring subscriber by the access network, by way of an additional process, in order to be integrated into the HTTP inquiry in the Web browser there.

Such conditions of an access network prevail, for example, in a GSM mobile phone network, in which the geographical position of the subscriber is available in the home register HLR (Home Location Register), but there is no possibility of automatically passing this information on to the subscriber. Using the example of a driver who is looking for a hotel in a remote region, the point of being able to access these automatically generated data becomes obvious.

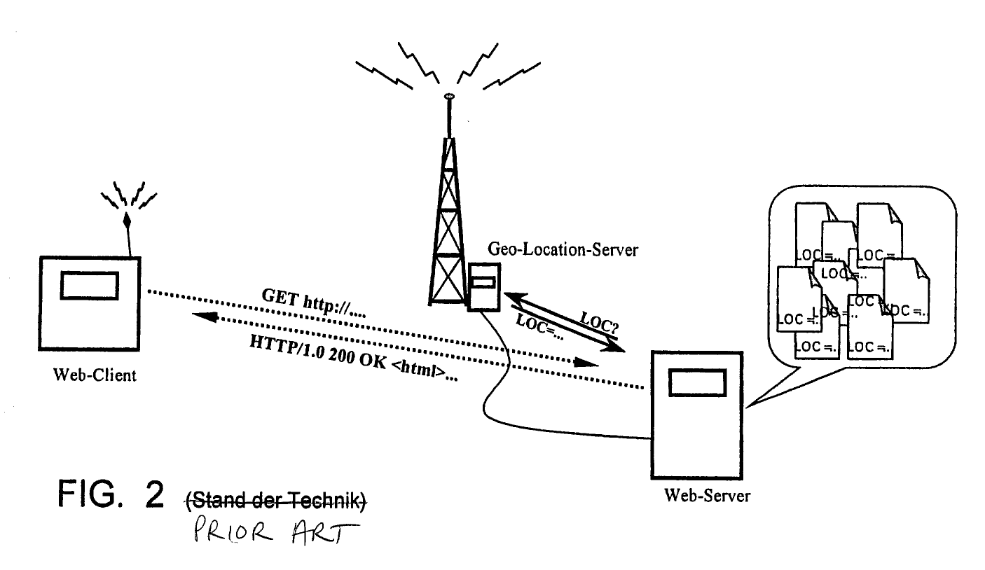

Making geographically-dependent data available is currently being discussed and planned in the WAP environment. In this connection, the data available in the home register, concerning the present location of the subscriber, is supposed to be made available to the information providers by way of a special location server, as is shown in FIG. 2. Since the geographical data are not implicitly transmitted with every information request, but rather made available to the information provider or the location server by a third party, a relation between the information request and the geographical location of the inquiring party is required, which is formed in the WAP environment by the identity of the subscriber. Since access to the user database of the network operator is necessary in the WAP, by using a special location server, the providers can only make geographically dependent information offers available within the scope of a special agreement with the network operator. Open access to the location server is not possible for reasons of data privacy protection.

It can therefore be expected that the complicated legal and technical situation in the case of WAP will prevent utilization of the geographical information over a large area, and that therefore a very essential element of mobile data use will not be implemented on the market.

The invention is based on the task of making available an improved method and an improved communications system for making available geographical data when calling up information in a communications network, such as the WWW or WAP service.

This task is accomplished by means of the method with the characteristics of claim 1, and by the mobile communications system with the characteristics of claim 9, respectively.

Advantageous further developments are the object of dependent claims.

A simple method for requesting position-related data from a network server is proposed, by passing the data request of a data terminal on by way of an interconnected station, and by supplementing the information request with geographical data or location data in the interconnected station.

Using a special network access computer or Web proxy server as the interconnected station makes simple implementation of the system possible with little effort and expense, since the many existing data terminals would not have to be reprogrammed and/or refitted.

Having the interconnected station make the sender of an information request anonymous with regard to the geographical location information, relative to the station providing the information, offers the advantage for the operator of the communications network that the legal requirements with regard to passing on subscriber-related data can be fulfilled by means of a central adjustment.

Allowing the user of the data terminal to select the extent to which he/she wishes to utilize the geographical location information and the extent to which he/she wishes to reveal his/her identity in this connection, by selecting and entering an appropriate interconnected station in his/her terminal, gives the information-requesting subscriber the possibility of freely deciding whether he/she wishes to remain anonymous. This again would fulfill the security obligation of the network operators with regard to their subscribers, concerning passing on a geographical location to a provider. The customer himself/herself decides whether and to what extent his/her geographical location will be passed on.

Establishing the communications connection by way of a mobile connection of a mobile interface of a mobile communications network, particularly a packet-oriented communications network, allows subsequent use in existing mobile telephone networks. The WAP standard of GSM, UMTS mobile telephone systems or future mobile telephone systems can be used, in particular, for a data exchange.

In particular, the conventional Web semantics can also be maintained, which have led to the resounding success of the WWW. Client-server implementation can be implemented in simple manner. Furthermore, use in the WAP environment is also easily possible.

The location information added in the interconnected station can advantageously relate to the geographical location of the interconnected station, the geographical location of the data terminal, a registration location of the data terminal, and/or the geographical location of the station providing the information.

In the following, an exemplary embodiment will be explained in greater detail on the basis of the drawing. This shows:

FIG. 1 a known information request from a network client to a network server, which provides this information directly with a location reference,

FIG. 2 a known information request from a network client to a network server, which provides this information with location information that is requested from a separate location server by the network server,

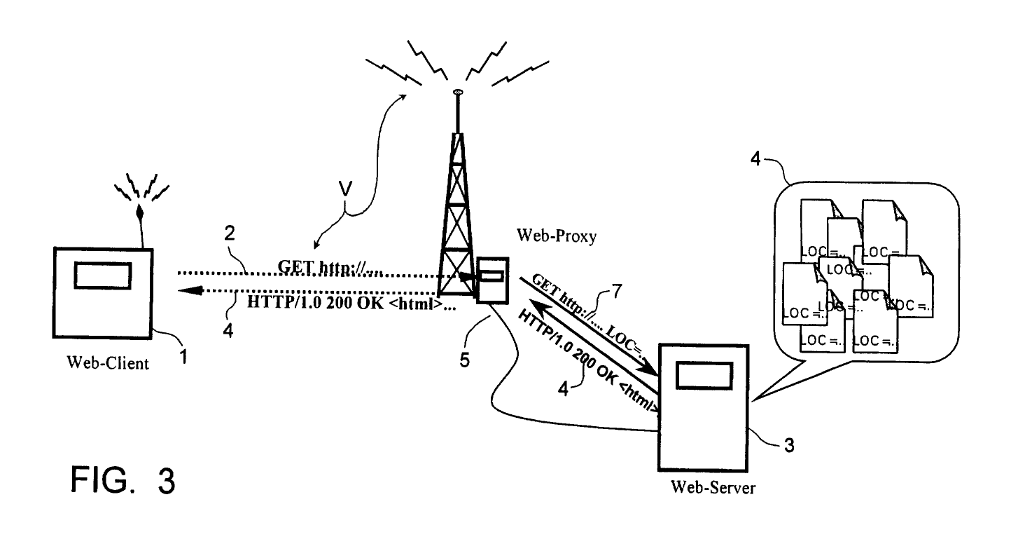

FIG. 3 a location-dependent information request from a network client to a network server, where this request takes place by way of an interconnected proxy server.

As is evident from FIG. 3, a network customer or Web client has established a communications connection V with a communications network by way of his/her data terminal 1.

In the exemplary embodiment shown, on the client side, the communications network is a mobile communications network, particularly a packet-oriented communications network, with the communications connection being established by way of a mobile connection V or a mobile interface. Such communications are currently known, particularly from the so-called WAP (Wireless Application Protocol), which is set up as an interface to the Internet in GSM mobile telephone systems. The data terminal 1 can therefore preferably be a mobile telephone station of this standard or a future standard.

In this connection, the inquiry from the data terminal 1 of the network client for data that can be provided from a network server or Web server, as outlined, is directly linked with a location inquiry or is indirectly linked with a location inquiry as a function of the information data. Accordingly, the Web server 3 provides information that is also referred to as location-dependent information data 4 in the following.

In order to improve the transmission of location-dependent information data 4, the communications connection between the data terminal 1 and the network server 3 is not established directly, but rather by way of a special network proxy server or Web proxy server 5. This Web proxy server 5 is interconnected at a central location between the data terminal 1 of the Web client and the Web server 3.

Web proxy servers are currently known, in and of themselves, and are widely used in the currently widespread WWW (World Wide Web) as network access computers, in order to reduce the network load. They serve to automatically put files into local temporary memory and to take them out of the local memory when they are called up again, and not to retransmit them over the Internet. In addition, they serve to allow subscribers from a private IP address region (IP: Internet Protocol) access to the public WWW, which is done in connection with a network address translation.

The Web proxy server 5 being proposed here accepts the HTTP inquiries 2 of the data terminal 1 of the Web client, and supplements the inquiries with the information (LOC= . . . ) concerning the current geographical location of the data terminal 1 and/or its own geographical location. This geographical location-dependent inquiry 6 is passed on to the relevant network server 3 by the Web proxy server 5, directly or indirectly, and processed accordingly there. The information sent back by the network server 3 to the data terminal 1 of the Web client is therefore information data 4 that is dependent on a geographical location. If no location-dependent data 4 are present under the requested URL, normal data are sent. The data transmission from the network server 3 to the data terminal 1 can take place directly, or, as shown, by way of the interconnected Web proxy server 5.

Since a Web proxy server 5 represents a central network element in the Internet access network, the subscribers do not all have to switch their data terminals 1 over to a new network access program or system, which is generally referred to as a Web browser, but instead can continue to use their usual browser. The expansions for the transmission and evaluation of the geographical location only have to be installed at the central locations, in this case, the Web proxy server 5 and the Web server 3. These make up only a fraction of the number of installed Web browsers and are furthermore managed by professionals, so that a conversion there can take place without problems and under expert supervision. An update of the software at these central locations is therefore easily possible.

The use of a special Web proxy server 5 for inserting the geographical location into an HTTP inquiry also solves the problem of data privacy protection with regard to individual movement profiles, as follows.

If the identity of the subscriber becomes visible for the provider or the operator of the network server 3 when the geographical location is made available by way of a separate interface, in this case, the Web proxy server 5, the identity of the requesting party can be concealed by way of the normal function of a Web proxy server 5, in combination with the so-called NAT functionality, which sets all HTTP inquiries to a common IP address and makes them anonymous.

If, in addition, a “geo-location” Web proxy server without NAT function and a normal Web proxy server with NAT function are made available, the subscriber alone has the ability to decide to what extent he/she wishes to utilize the location information and to what extent he/she wishes to reveal his/her identity in this connection, by entering the appropriate proxy server in the browser of his/her data terminal 1.

In this way, the network operators' security obligation with regard to their subscribers, concerning passing a geographical location on to a provider, would be fulfilled. The customer himself/herself decides whether and to what extent his/her geographical location will be passed on.

On the other hand, the network operator no longer needs a special interface for passing on the geographical location to the service provider, since the information is passed on directly in the inquiries, i.e., HTTP requests. The organizational and technical effort and expense for making geographical location available in the WWW is therefore minimal.

If the subscriber dials into the communications network by way of a land-line network, instead of establishing a mobile communications connection, the subscriber currently generally dials into the Internet in the same local network region, i.e., at a nearby geographical position, for cost reasons. If a geo-location Web proxy server 5 or local position network access computer is set up there, which permanently includes its own geographical position in the HTTP inquiries, the information transmitted in this way is applicable to most network customers, without having to provide special provisions for user-dependent determination of the geographical position.

If a network customer wishes to insert his/her registration location or to insert the location information of the network server 3 into the inquiry to the network server 3 instead of the current location information of his/her data terminal 1, this can be done in accordance with an alternative embodiment.

1. Method for making geographical data available when data are called up from a communications system, wherein
information is requested by a data terminal (1) by way of at least one communications connection (V) with a communications network of a station (3) providing information, by means of an information request (2),
the request for the information being passed on by way of an interconnected station (5),
characterized in that
the interconnected station (5) supplements the information with geographical information (7).

2. The method as recited in claim 1, wherein the station (3) providing the information provides geographical information (4) in accordance with the geographical location information (4) in the request.

3. The method as recited in a previous claim, wherein a special network access computer or Web proxy server (5) is used as the interconnected station for transmitting the information request (2).

4. The method as recited in a previous claim, wherein the interconnected station (5), when supplementing the information request (2) by the geographical location information, makes the sender (1) anonymous with regard to the information-providing station (5).

5. The method as recited in a previous claim, wherein the user of the data terminal (1) selects to what extent he/she wishes to utilize the location information and, in this connection, to what extent he/she wishes to reveal his/her identity, by selecting and entering an appropriate interconnecting station (5).

6. The method as recited in a previous claim, wherein the communications connection is established by way of a mobile telephone connection (V) of a mobile interface of a mobile communications network, with the WAP standard of GSM or UMTS mobile telephone systems or future mobile communications systems, in particular, being used for data exchange.

7. The method as recited in a previous claim, wherein the location information (7) that is added in the interconnected station (5) relates to the geographical location of the intermediate station (5) and/or the geographical location of the data terminal (1) and/or a registration location of the data terminal (1) and/or the geographical location of the station (3) providing the information.

8. The method as recited in claim 7, wherein the geographical location to be added is selected by an optional preliminary setting in the data terminal (1) and/or in the interconnected station (5).

9. Communications system for implementing a method for making geographical data available when data are called up from a communications system, particularly as recited in one of the previous claims, with
a communications network for establishing and maintaining a communications connection (V) between a data terminal (1) and a station (3) providing information, from which the data terminal (1) can request information by means of an information request (2), and
at least one interconnected station (5), by way of which the information request (2) coming from the data terminal (1) is passed along,
characterized in that
the interconnected station (5) has a supplementing device for supplementing the information request (2) with geographical location information (7).

10. The communications system as recited in claim 9, wherein the interconnected station is a special network access computer or Web proxy server (5) that is particularly dialed up directly by the data terminal (1).

11. The communications system as recited in claim 9 or 10, the communications system being a mobile communications system.
